(19) United States
(12) Patent Application Publication
(10) Pub. No.: US 2026/0337382 A1
(43) Pub. Date: Oct. 29, 2026

(54) FLAME-RETARDANT PLASTIC PRODUCTS

(71) Applicant: LANXESS Deutschland GmbH, Cologne (DE)

(72) Inventors: Lars May, Langenfeld (DE); Wolfgang Wambach, Cologne (DE)

(73) Assignee: LANXESS Deutschland GmbH, Cologne (DE)

(21) Appl. No.: 19/556,413

(22) Filed: Mar. 4, 2026

(30) Foreign Application Priority Data
Mar. 6, 2025 (EP) 25161996.1

(51) Int. Cl. C08K 13/04; C08J 3/20; C08J 5/04; C08K 5/3447; C08K 5/52; C08K 5/5313; C08K 5/5333; C08K 7/14

(52) U.S. Cl. CPC C08K 13/04; C08J 3/203; C08J 5/043; C08J 2367/02; C08K 5/3447; C08K 5/5205; C08K 5/5313; C08K 5/5333; C08K 7/14; C08K 2201/004; C08K 2201/014

(57) ABSTRACT

The present invention relates to flame-retardant plastic products made from polyester-based moulding compounds comprising at least one phosphinic salt and/or at least one diphosphinic salt as flame retardant, at least one flame retardant synergist and at least one colourant in the form of the isomer mixture of 9,9′-oxybis-12H-phthaloperin-12-one, 9,10-oxybis-12H-phthaloperin-12-one and 10,10′-oxybis-12H-phthaloperin-12-one, to the moulding compounds required for production of these plastic products, and to the use of the colourant for use in accordance with the invention for production of flame-retardant polyester-based moulding compounds or plastic products with high laser transparency.

The present invention relates to flame-retardant plastic products made from polyester-based moulding compounds comprising at least one phosphinic salt and/or at least one diphosphinic salt as flame retardant, at least one flame retardant synergist and at least one colourant in the form of the isomer mixture of 9,9′-oxybis-12H-phthaloperin-12-one, 9,10-oxybis-12H-phthaloperin-12-one and 10,10′-oxybis-12H-phthaloperin-12-one, to the moulding compounds required for production of these plastic products, and to the use of the colourant for use in accordance with the invention for production of flame-retardant polyester-based moulding compounds or plastic products with high laser transparency.

### PRIOR ART

Because of their good mechanical stability, chemical resistance and processibility, polyesters are an important material, for example, for use in motor vehicles, in components for the electrical and electronics industry, or in household appliances. In applications of polyester in the vicinity of live electrical parts, flame-retardant materials are frequently used in order thus to counteract the risk of a fire caused by overheated wires or contacts. According to the field of use, what are desired here are not only good self-extinction capacity, in particular a UL94 V-0 classification according to Underwriters Laboratories Inc. Standard of Safety, “Test for Flammability of Plastic Materials for Parts in Devices and Appliances”, p. 14-18 Northbrook 1998, but also low ignitability.

In the field of polyesters, there has recently been increasing call for halogen-free solutions, for environmental reasons, but also because polyesters with halogen-free flame retardants, compared to halogen-containing systems, generally not only reduce the flammability of articles and hence delay the development of fires, but additionally reduce evolution of smoke, prevent toxic gases and are at the same time environmentally friendly and beneficial to health. The desire for maximum design freedom and hence greater complexity of the component geometry, in conjunction with the cost-driven need for automatable and readily integratable mass production processes, is increasingly requiring materials that can additionally be joined to one another by the laser transmission welding process; see: E. Haberstroh, W.-M. Hoffmann, Laserdurchstrahlschweißen von Kunststoffen—Elastomere und Kunststoffe, KGK-Rubberpoint, 11.2006, p. 590-595. For a laser-transparent joining partner, this requires a high degree of transmission at the laser wavelength to be employed. The latter is a major challenge for flame-retardant polyesters, since flame retardants scatter or even absorb laser light, as is the case, for example, with antimony trioxide, which is used as a flame retardant synergist in halogen-containing flame retardants. An additional challenge in the case of coloured polyesters is the colourant used.

WO 2009/066232 A1 describes NIR-absorbing moulding compounds that can be used in laser welding processes. Various pigments are used to reduce NIR transmission in plastics including polyesters, also including TiO₂ pigments with average particle sizes of 30 nm to 4.35 μm. Laser-transparent moulding compounds are not described specifically in WO 2009/066232 A1.

High processing temperatures of in some cases>300 °C, especially in compounding and injection moulding, but also the presence of additives, in particular flame retardants, greatly restrict the selection of suitable colourants in polyesters, especially for orange marking of essential components for electric drivetrains. The colour orange for marking electrical equipment of machines is specified in VDE 0113-1 “Safety of machinery—Electrical equipment of machines—Part 1: General requirements”, section 13.2.4, where orange is stipulated for use only for “excluded circuits” according to section 5.3.5. The standard CEI EN 60204-1:2006 (CEI 44-5 “Safety of machinery—Electrical equipment of machines”) states that orange is used for circuits where the supply cannot be interrupted by a circuit breaker. Orange has therefore become established for identification of key components for electric drivetrains.

It should additionally be taken into account that dyes in polyesters, under extreme demands as occur in the processing of polyesters in particular, have a tendency to cause colour streaks, particularly on the surfaces of injection-moulded products close to the injection points, or to become discoloured.

When organic dyes soluble in the polymer are used, for example from EP 0 035 672 B1 in the case of isoindoline dyes, the person skilled in the art is familiar with the phenomenon of browning, which is attributable to thermal damage to the dye.

By contrast, undesirable colour streaks occur when the colourant has been inadequately mixed in, when colourant and plastic to be processed are incompatible with one another, or when demixing occurs on account of excessive shear during injection moulding. There are numerous sources of error for the occurrence of such undesirable colour streaks. Examples include apparatus-related sources of error in the mixing screw, mixing barrels that are too small, defective colour metering, an excessively large material hopper or electrostatic charging of the colour or colourant. Material-related sources of error can include incompatibility of masterbatch or colourant with the plastic to be processed, inadequate solubility of the colourant in the plastic to be processed, thermal sensitivity of the colourant, excessively large pellets or excessive pigment content. Methodology-related sources of error may include too low a backpressure during injection moulding, excessively high screw speed, excessively high or excessively low melt temperature, excessively high or excessively low injection rate, excessively high or excessively low mould temperature or inadequate or excessive colour metering. Finally, the occurrence of colour streaks can also be promoted by mould-related sources of error such as flow cross sections that are too small, flow paths that are too long, an unsuitable position of weld seams, or sections on the injection-moulded article that are too small for injection moulding. Especially in the case of glassfibre-reinforced injection mouldings, processing of orange polyester-based moulding materials with reduced streaking, if not without streaking, in particular by injection moulding, is therefore a particular challenge for a person skilled in the art.

EP 3 421 540 A1 discloses polyester-based resin compositions that have been coloured black with the anthraquinone dyes Solvent Blue 104, Solvent Blue 97 and Solvent Yellow 163, with the perinone dye Solvent Red 179 and with the azomethine dye Solvent Brown 53, and have been welded to a second polyester component containing nigrosin to form a specimen of black appearance overall. Although a perinone dye is used in EP 3 421 540 A1 in the form of Solvent Red 179, EP 3 421 540 A1 does not relate to the laser transparency of orange polyester, nor to the problem of the presence of flame retardants. Apart from the fact that the problem addressed in EP 3 421 540 A1 was that of welding together two components of black appearance in order to produce a visually uniform product, the problem of browning through the effect of heat on the polyester and/or on the dye, whether in laser welding or compounding, is not considered in EP 3 421 540 A1.

WO 2020/187704 A1 discloses high-voltage components based on polymer compositions containing at least one polyester and 10,10′-oxybis-12H-phthaloperin-12-one.

WO 2025/003531 A1, finally, describes electromobility components having a colour distance ΔE<20 of the L*a*b* coordinates from a colour number of the RAL colour chart beginning with “2”, comprising polymer compositions based on at least one polyester and a colourant having a median particle size d50 determinable by laser diffractometry according to ISO 13320 in the range from 1 to 12 μm, comprising 9,9′-oxybis-12H-phthaloperin-12-one, 9,10-oxybis-12H-phthaloperin-12-one and 10,10′-oxybis-12H-phthaloperin-12-one in a ratio of 1:1:0.8-1.5 to 1:1.5:0.8-1.5, where there are 0.01 to 5 parts by mass of colourant based on 100 parts by mass of polyester in the polymer compositions.

Therefore, proceeding from the prior art, it was an object of the present invention to provide plastic products comprising halogen-free flame-retardants and made from polyester-based polymer compositions which, on the one hand, enable the production of streak-free orange plastic products without browning by virtue of the polyester-soluble colourant to be used, but at the same time also have sufficient laser transparency in order to be processible even in downstream laser-based processing processes without deterioration with respect to the UL 94 results of a non-orange-coloured sample with otherwise the same composition.

It has now been found that, surprisingly, the stated requirements are met by plastic products made from polymer compositions comprising at least one polyester, at least one flame retardant consisting of at least one phosphinic salt and/or at least one diphosphinic salt and/or polymers thereof, at least one flame retardant synergist and at least one colourant in the form of the isomer mixture of 9,9′-oxybis-12H-phthaloperin-12-one, 9,10-oxybis-12H-phthaloperin-12-one and 10,10′-oxybis-12H-phthaloperin-12-one.

### Subject—Matter of the Invention

The invention provides plastic products made from polymer compositions comprising
a) at least one polyester,
b) at least one flame retardant composed of at least one phosphinic salt of the formula (I) and/or at least one diphosphinic salt of the formula (II) and/or polymers thereof

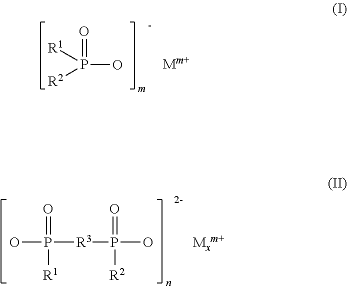

in which
R¹, R² are the same or different and are a linear or branched C₁-C₆-alkyl and/or C₆-C₁₄-aryl,
   R³ is linear or branched C₁-C₁₀-alkylene, C₆-C₁₀-arylene or C₁-C₆-alkyl-C₆-C₁₀-arylene or C₆-C₁₀-aryl-C₁-C₆-alkylene,
   M is aluminium or zinc,
   m is an integer from 1 to 4;
   n is an integer from 1 to 3 and
   x is 1 or 2,
   where n, x and m in formula (II) may at the same time assume only such integer values that the diphosphinic salt of the formula (II) as a whole is uncharged,
c) at least one flame retardant synergist to be selected from melamine polyphosphate and aluminium phosphonate, and
d) at least one colourant in the form of the isomer mixture of 9,9′-oxybis-12H-phthaloperin-12-one, 9,10-oxybis-12H-phthaloperin-12-one and 10,10′-oxybis-12H-phthaloperin-12-one.

The invention preferably relates to plastic products made from polymer compositions comprising
a) at least one polyester,
b) at least one flame retardant composed of at least one phosphinic salt of the formula (I)

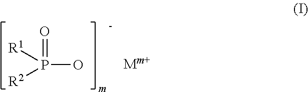

in which
R¹, R² are the same or different and are a linear or branched C₁-C₆-alkyl,
M is aluminium or zinc,
m is an integer from 1 to 4;
c) at least one flame retardant synergist to be selected from melamine polyphosphate and aluminium phosphonate, and
d) at least one colourant in the form of the isomer mixture of 9,9′-oxybis-12H-phthaloperin-12-one, 9,10-oxybis-12H-phthaloperin-12-one and 10,10′-oxybis-12H-phthaloperin-12-one.

More preferably, the invention relates to plastic products with a colour distance ΔE<20, to be determined according to DIN 5033 (1979), of the L*a*b* coordinates from a colour number beginning with “2” in the RAL colour chart according to EN-ISO 11664-4, comprising a) at least one polyester and the abovementioned components b), the at least one flame retardant, c) the at least one flame retardant synergist and d) the at least one colourant.

Even more preferably, the invention relates to plastic products with a colour distance ΔE<10, to be determined according to DIN 5033 (1979), of the L*a*b* coordinates from a colour number beginning with “2” in the RAL colour chart according to EN-ISO 11664-4, comprising a) at least one polyester and the abovementioned components b), the at least one flame retardant, c) the at least one flame retardant synergist and d) the at least one colourant.

More especially preferably, the invention relates to plastic products with a colour distance ΔE<5, to be determined according to DIN 5033 (1979), of the L*a*b* coordinates from a colour number beginning with “2” in the RAL colour chart according to EN-ISO 11664-4, comprising a) at least one polyester and the abovementioned components b), the at least one flame retardant, c) the at least one flame retardant synergist and d) the at least one colourant.

Preferably, the following are used for every 100 parts by mass a) of the at least one polyester:
2 to 100 parts by mass, preferably 5 to 60 parts by mass, more preferably 7 to 40 parts by mass, especially preferably 8 to 30 parts by mass, of b) the at least one flame retardant,
0.2 to 50 parts by mass, preferably 0.5 to 40 parts by mass, more preferably 0.75 to 35 parts by mass, of c) the at least one flame retardant synergist
and 0.01 to 5 parts by mass of d) the at least one colourant in the form of the isomer mixture of 9,9′-oxybis-12H-phthaloperin-12-one, 9,10-oxybis-12H-phthaloperin-12-one and 10,10′-oxybis-12H-phthaloperin-12-one.

For the sake of clarity, it should be noted that the scope of the present invention encompasses all the definitions and parameters cited in general or in preferred ranges, in any desired combinations. This relates in particular to the above combinations of the stated amounts of the individual components with respect to the polymer compositions according to the invention and the plastic products to be produced therefrom, and also to the methods and uses claimed in the context of the present invention. The standards cited in the context of this application relate to the current version at the filing date of the present invention. Unless stated otherwise, reported percentages are percentages by weight.

### Laser Transmission Welding

It is a prerequisite for the employment of laser transmission welding as a method of bonding two plastic mouldings that the radiation emitted by the laser first penetrates a moulding of sufficient transparency for laser light of the NIR wavelength used (also referred to as NIR-transparent moulding). For this purpose, the wavelength is preferably in the range of 800 nm to 1200 μm. Transparency is sufficient when the first moulding is at least partly transmissive for NIR radiation. This has the effect that the NIR radiation hits the second moulding to a sufficient degree to enable a firm bond between the two mouldings by laser welding. The first moulding preferably at least in part has transmittance for NIR radiation of at least 10%. What is meant here by “at least in part” is that this specified transmittance of at least 10% is satisfied at least in the region corresponding to the welding region. Outside this welding region, the specified transmittance of at least 10% is not required. Preferably, however, the entire moulding to be penetrated by laser radiation has transmittance of at least 10%. The NIR radiation that penetrates the first moulding ultimately hits the welding region, where it is absorbed in a thin layer of the second moulding, with the NIR-absorbing moulding in contact with the NIR-transparent moulding. In the thin layer of the second moulding that absorbs the NIR laser light, the laser energy is converted to heat, which results in melting in the welding region and ultimately in bonding of the NIR-transparent moulding to the NIR-absorbing moulding. Lasers in the wavelength range of 800 nm to 1200 nm are typically used for laser transmission welding. In the wavelength range of the lasers used for thermoplastic welding, Nd:YAG lasers (1064 nm) or high-performance diode lasers (800-1000 nm) are customary. Several laser welding process variants are available to the skilled person, all of which are based on the principle of transmission. For instance, contour welding is a sequential welding process in which either the laser beam is guided along a freely programmable seam contour, or the component is moved relative to the fixedly installed laser. In simultaneous welding, the emitted radiation in a linear manner from individual high-performance diodes is arranged along the seam contour to be welded. The melting and welding of the entire contour is thus simultaneous. Quasi-simultaneous welding is a combination of contour welding and simultaneous welding. The laser beam is guided along the weld seam contour with the aid of galvanometric mirrors (scanners) at a very high speed of 10 m/s or more. Owing to the high speed, the joining area is gradually heated and melted. Compared to simultaneous welding, there is a high degree of flexibility in the event of changes in the weld seam contour. Mask welding is a process in which a linear laser beam is moved across the parts to be joined. The radiation is selectively shaded by a mask and only hits the joining surface where welding is to be effected. The process allows the production of very exactly positioned welds. These methods are known to the skilled person, for example, from “Handbuch Kunststoff-Verbindungstechnik [Handbook of Plastics Joining Technology]” (G. W. Ehrenstein, Hanser, ISBN 3-446-22668-0) and/or DVS Directive 2243 “Laserstrahlschweißen thermoplastischer Kunststoffe [Laser Beam Welding of Thermoplastics]”.

Variants of laser transmission welding that are preferred in accordance with the invention are therefore contour welding, simultaneous welding, quasi-simultaneous welding, the TWIST® approach, mask welding, radial welding, Globo welding and hybrid welding.

Although the NIR transparencies of the various thermoplastics may vary, the standard thermoplastics do have sufficiently high transparency in the NIR region, such that laser welding processes are performable when suitable process parameters are chosen (thickness of the NIR-transparent joining partner, intensity of the laser beam, speed of the welding process, selection of suitable additives in the thermoplastic). Owing to the low NIR absorption of thermoplastics, the joining partner that absorbs the laser light is typically modified with an NIR-absorbing admixture. Particularly suitable for this purpose are pigments having maximum absorption in the wavelength range of the welding laser. A particularly suitable and widespread practice is the use of any kind of soot as NIR-absorbing pigments. Therefore, the NIR-absorbing joining partners are usually dark-coloured to black. If the NIR-transparent joining partner is to have a colour similar to that of the NIR-absorbing partner, it should be ensured that the colouring of the NIR-transparent joining partner takes place primarily in the wavelength range perceptible to the human eye (about 380 to 750 nm) and that there is minimum impairment of NIR transmission. Two types of colourants are generally available for colouring of plastics: pigments and soluble dyes (sometimes also referred to simply as “dyes”). The scattering of NIR light by colourants can be largely avoided if soluble dyes are used, since they can be distributed in the thermoplastic up to molecular dispersancy and hence do not constitute a scattering source for NIR light. Furthermore, the NIR absorption of the soluble dyes should be at a minimum.

The at least one polymer-soluble dye which is to be used for orange identification of polyester-based plastic products in the context of the present invention and which additionally fulfils the requirement of laser transparency or slight impairment of NIR transmission is the isomer mixture in the form of 9,9′-oxybis-12H-phthaloperin-12-one, 9,10-oxybis-12H-phthaloperin-12-one and 10,10′-oxybis-12H-phthaloperin-12-one.

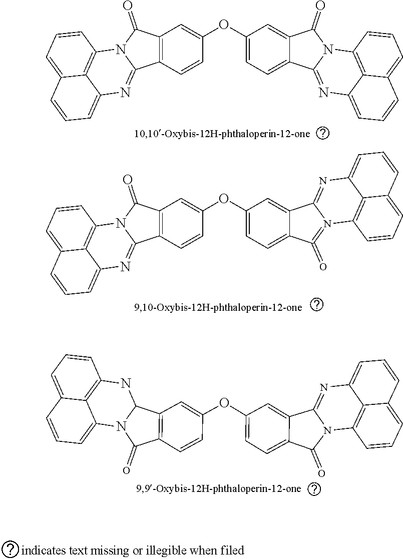

The colourant to be used in accordance with the invention is preferably obtainable by the method according to synthesis specification 2 in DE 20 2024 001 709 U1 with an isomer ratio of 9,9′-oxybis-12H-phthaloperin-12-one, 9,10-oxybis-12H-phthaloperin-12-one and 10,10′-oxybis-12H-phthaloperin-12-one in the range of 1:1:0.8-1.5 to 1:1.5:0.8-1.5. The colourant to be used in accordance with the invention preferably has a median particle size d50 to be determined according to ISO 13320 by laser diffractometry in the range of 1 to 20 μm, more preferably a median particle size d50 in the range of 1 to 10 μm.

The finding obtained from the experiments in the context of the present invention that the colourant to be used in accordance with the invention shows high NIR transmittance in polyesters, at the same time interacts neither with the flame retardant to be used as component b) nor with the flame retardant synergist c), and additionally withstands high processing temperatures and hence does not show any browning, enables the use of flame-retardant orange polymer compositions according to the invention and plastic products to be produced therefrom that at least have reduced streaking, preferably in applications where laser transparency is required.

The invention therefore preferably relates to polymer compositions and plastic products which are laser-transparent, orange, flame-retardant products or joining partners, in particular those for use as components for the electric drivetrains of motor vehicles, called electromobility components.

The colourant to be used in accordance with the invention in the form of the isomer mixture of 9,9′-oxybis-12H-phthaloperin-12-one, 9,10-oxybis-12H-phthaloperin-12-one and 10,10′-oxybis-12H-phthaloperin-12-one can be used directly as powder, or else in the form of a masterbatch, in the form of a compact or in the form of a concentrate, preferably masterbatches and more preferably masterbatches in a polyester matrix.

### Laser Transparency

The laser transparency to be determined in the context of the present invention on test specimens is guided by the fact that incident radiation is divided into two portions depending on the absorption capacity and thickness of the plastic part to be examined, which can be detected by metrology.

According to the invention, high laser transmittance means laser transmittance of at least 30%, preferably at least 40%, more preferably at least 50%, measured on sample plaques of a thickness of 0.75 mm with the LPKF TMG3 transmission measurement device from LPKF Laser 8 Electronics AG, Garbsen, Germany, at a laser wavelength of 980 nm. The LPKF TMG3 transmission measurement device is a certified, traceably calibrated measuring instrument. Its metrological capacity was demonstrated in a statistical measurement system analysis (MSA). The device is additionally compliant with the specifications of automotive standard IATF 16949 and is therefore directly qualified for standard-compliant quality assurance. Nd:YAG lasers (1064 nm) or high-performance diode lasers (800-1000 nm) are preferably employed in the context of the present invention. The measurements in the context of the present invention are based on DVS Guideline 2243 (January 2014) “Laserstrahlschweißen thermoplastischer Kunststoffe [Laser beam welding of thermoplastics]” using round plaques with diameter 80 mm and thickness 0.75 mm in the near infrared (NIR). The LPKF TMG3 transmission measurement device from LPKF Laser & Electronics AG is calibrated before the measurements with a measurement standard produced in accordance with DIN EN ISO/IEC 17025. The measurements are made in the context of the present invention at a laser wavelength of 980 nm.

A reduction in transmittance of <3% at 980 nm compared to a plastic sample without component d), the colourant in the form of the isomer mixture of 9,9′-oxybis-12H-phthaloperin-12-one, 9,10-oxybis-12H-phthaloperin-12-one and 10,10′-oxybis-12H-phthaloperin-12-one, is rated +++ in the context of the present invention. A reduction in transmittance at 980 nm in the range from 3% to 5% compared to a plastic sample without component d), the colourant in the form of the isomer mixture of 9,9′-oxybis-12H-phthaloperin-12-one, 9,10-oxybis-12H-phthaloperin-12-one and 10,10′-oxybis-12H-phthaloperin-12-one, is rated ++ in the context of the present invention. A reduction in transmittance at 980 nm in the range from 5% to 10% compared to a plastic sample without component d), the colourant in the form of the isomer mixture of 9,9′-oxybis-12H-phthaloperin-12-one, 9,10-oxybis-12H-phthaloperin-12-one and 10,10′-oxybis-12H-phthaloperin-12-one, is rated only + in the context of the present invention.

### Compounding

Polymer compositions for production of flame-retardant plastic products according to the invention are prepared by compounding and subsequent processing by injection moulding, extrusion, or by blow moulding, by mixing the at least one polyester to be used as reactant with b) the at least one flame retardant, c) the at least one flame retardant synergist and d) the at least one colourant in the form of the isomer mixture of 9,9′-oxybis-12H-phthaloperin-12-one, 9,10-oxybis-12H-phthaloperin-12-one and 10,10′-oxybis-12H-phthaloperin-12-one in at least one mixing tool in the ratio specified above. This affords polymer compositions in the form of moulding materials that either consist exclusively of the components mentioned or else also contain at least one further component in addition to these components. The flame-retardant plastic products according to the invention are therefore preferably injection-moulded, extruded or blow-moulded products, in particular injection-moulded products.

The processing of polyesters in the injection moulding, extrusion or blow moulding processes mentioned reaches temperatures up to the melting points of the polyesters to be used. The melting points of polyesters that are of industrial significance and therefore preferred in accordance with the invention are in the region of 220 °C for polybutylene terephthalate, in the range of 220 to 230 °C for polycarbonate, and in the range of 235 to 260 °C for polyethylene terephthalate.

The invention preferably relates to plastic products based on at least one polyester, in particular polybutylene terephthalate or polycarbonate, which are injected at a melt temperature in the range of 220 to 270 °C. Preferably, in injection moulding, the injection mould is at a mould temperature in the range of 70 to 100 °C. In the injection moulding of the at least one polyester, in particular polybutylene terephthalate or polycarbonate, an injection pressure in the range of 60 to 100 MPa is preferably employed.

Surprisingly, the colourant to be used in accordance with the invention in the form of the isomer mixture of 9,9′-oxybis-12H-phthaloperin-12-one, 9,10-oxybis-12H-phthaloperin-12-one and 10,10′-oxybis-12H-phthaloperin-12-one is thermally stable to the extent that it does not brown in the methods of processing polyesters that have been mentioned.

With the isomer mixture of 9,9′-oxybis-12H-phthaloperin-12-one, 9,10-oxybis-12H-phthaloperin-12-one and 10,10′-oxybis-12H-phthaloperin-12-one, plastic products are produced that have a colour distance of ΔE<20, determinable in accordance with EN ISO 11664-4, from a colour number beginning with “2” in the L*a*b* system of the RAL colour chart.

Flame-retardant plastic products according to the invention are preferably coloured orange by the colourant in the form of the isomer mixture of 9,9′-oxybis-12H-phthaloperin-12-one, 9,10-oxybis-12H-phthaloperin-12-one and 10,10′-oxybis-12H-phthaloperin-12-one, with particular preference for shades corresponding in the RAL colour system to colour numbers RAL2001, RAL2003, RAL2004, RAL2007, RAL2008, RAL2009, RAL2010 and RAL2011, and very particular preference for shades corresponding in the RAL colour system to colour numbers RAL 2001, RAL2003, RAL2008, RAL 2010 and RAL2011.

“Similar shades” that are permissible in accordance with the invention and encompassed by the present invention are those having a colour distance in the L*a*b* system with a ΔE of <20, preferably ΔE<10, more preferably ΔE<5 from a colour number beginning with a “2” in the RAL colour chart. For elucidation of ΔE as defined in EN ISO 11664-4, see for example https://de.wikipedia.org/wiki/Delta_E.

### Orange

In the context of the present invention, orange is considered to mean a colour which, in the RAL colour system according to https://de.wikipedia.org/wiki/RAL-Farbe#Orange, has a colour number beginning with a “2” in the RAL colour chart. In particular, at the filing date of the present invention, a distinction is made between orange hues according to Tab. 1:

TABLE 1

| | | L* | a* | b* |
|---|---|---|---|---|
| RAL 2000 | Yellow orange | 58.20 | 37.30 | 68.68 |
| RAL 2001 | Red orange | 49.41 | 39.79 | 35.29 |
| RAL 2002 | Vermilion | 47.74 | 47.87 | 33.73 |
| RAL 2003 | Pastel orange | 66.02 | 41.22 | 52.36 |
| RAL 2004 | Pure orange | 56.89 | 50.34 | 49.81 |
| RAL 2005 | Luminous orange | 72.27 | 87.78 | 82.31 |
| RAL 2007 | Luminous bright orange | 76.86 | 47.87 | 97.63 |
| RAL 2008 | Bright red orange | 60.33 | 46.91 | 60.52 |
| RAL 2009 | Traffic orange | 55.83 | 47.79 | 48.83 |
| RAL 2010 | Signal orange | 55.39 | 40.10 | 42.42 |
| RAL 2011 | Deep orange | 59.24 | 40.86 | 64.50 |
| RAL 2012 | Salmon orange | 57.75 | 40.28 | 30.66 |
| RAL 2013 | Pearl orange | 40.73 | 32.14 | 34.92 |

Tab. 1 shows the apparatus-independent CIE L*a*b* colour values for the respective RAL value: L* represents luminance, a* describes the colour locus with respect to the red-green axis and b* describes the colour locus with respect to the yellow-blue axis using D65 standard light with a 10° field of view of a standard observer. The colour model is standardized in EN ISO 11664-4 “Colorimetry—Part 4: CIE 1976 L*a*b* Colour space”. For L*a*b* colour space (also: CIELAB), see: https://de.wikipedia.org/wiki/Lab-Farbraum. Each colour in the colour space is defined by a colour locus having the Cartesian coordinates {L*, a*, b*}. The a*b* coordinate plane was constructed using opponent colour theory. Green and red are at opposite ends of the a* axis from one another and the b* axis runs from blue to yellow. Complementary shades are respectively opposite one another at a 180° angle; all achromatic colours are arranged in the middle thereof (the coordinate origin a*=0, b*=0).

The L* axis describes the brightness (luminance) of the colour with values of 0 to 100. In the diagram, it stands perpendicular to the a*b* plane at the origin. It may also be referred to as the neutral grey axis since all achromatic colours (grey hues) are between the endpoints of black (L*=0) and white (L*=100). The a* axis describes the green or red component of a colour, where negative values represent green and positive values represent red. The b* axis describes the blue or yellow component of a colour, where negative values represent blue and positive values represent yellow. The a* values range from approximately −170 to +100 and the b* values from −100 to +150, the maximum values being achieved only at moderate brightness of certain hues. The CIELAB colour entity has its greatest extent in the region of moderate brightness, but this differs in height and size depending on the colour range.

### Further Preferred Embodiments of the Invention

The invention preferably relates to plastic products having a colour distance ΔE<20, to be determined according to DIN 5033 (1979), of the L*a*b* coordinates from a colour number beginning with a “2” in the RAL colour chart according to EN ISO 11664-4.

The invention more preferably relates to plastic products that are characterized by a shade in the RAL colour system that corresponds to colour number RAL2001, RAL2003, RAL2004, RAL2007, RAL2008, RAL2009, RAL2010 or RAL2011.

The invention very particularly preferably relates to injection-moulded plastic products having a colour distance ΔE<20, to be determined according to DIN 5033 (1979), of the L*a*b* coordinates from a colour number beginning with a “2” in the RAL colour chart according to EN ISO 11664-4.

The invention relates especially preferably to injection-moulded plastic products that are characterized by a shade in the RAL colour system that corresponds to colour number RAL2001, RAL2003, RAL2004, RAL2007, RAL2008, RAL2009, RAL2010 or RAL2011.

In a preferred embodiment, the invention relates to plastic products having a colour distance ΔE<20 of the L*a*b* coordinates from a colour number starting with “2” in the RAL colour chart, based on polymer compositions containing, in addition to a) the at least one polyester, b) the at least one flame retardant, c) the at least one flame retardant synergist and d) the isomer mixture of 9,9′-oxybis-12H-phthaloperin-12-one, 9,10-oxybis-12H-phthaloperin-12-one and 10,10′-oxybis-12H-phthaloperin-12-one to be used as colourant, also e) at least one filler and/or reinforcer. Component e) is preferably used in amounts of 1 to 150 parts by mass, more preferably 5 to 80 parts by mass, most preferably 10 to 50 parts by mass, based in each case on 100 parts by mass of polyester.

In a further preferred embodiment, the invention relates to plastic products having a colour distance ΔE<20, to be determined according to DIN 5033 (1979), of the L*a*b* coordinates from a colour number starting with “2” in the RAL colour chart according to EN ISO 11664-4, based on polymer compositions containing, in addition to a) the at least one polyester, b) the at least one flame retardant, c) the at least one flame retardant synergist and d) the isomer mixture in the form of 9,9′-oxybis-12H-phthaloperin-12-one, 9,10-oxybis-12H-phthaloperin-12-one and 10,10′-oxybis-12H-phthaloperin-12-one to be used as colourant, additionally or alternatively to component e), also a component f), at least one additive. Component f) is preferably used in amounts of 0.01 to 80 parts by mass, more preferably 0.05 to 50 parts by mass, most preferably 0.1 to 30 parts by mass, based in each case on 100 parts by mass of polyester.

C₂-C₁₀ Polyalkylene Terephthalates for Use as Component a) Polyester

C₂-C₁₀ polyalkylene terephthalates to be used with preference in accordance with the invention as polyester in the context of the present invention are reaction products of an alcohol moiety having 2 to 10 carbon atoms in the alcohol moiety and terephthalic acid. C₂-C₁₀ polyalkylene terephthalates are known to those skilled in the art and extensively described in the literature. They contain an aromatic ring in the main chain which derives from the terephthalic acid and an aliphatic moiety which derives from a dihydroxy compound. The aromatic ring of the terephthalic acid may also be substituted. Preferred substituents are halogens or C₁-C₄ alkyl groups. Preferred halogens are chlorine or bromine. Preferred C₁-C₄ alkyl groups are methyl-, ethyl-, n-propyl- or n-, i- or t-butyl groups.

C₂-C₁₀ polyalkylene terephthalates usable with preference are obtainable by reaction of aromatic dicarboxylic acids, esters thereof or other ester-forming derivatives with aliphatic dihydroxy compounds in a manner known to those skilled in the art.

In the case of the C₂-C₁₀ polyalkylene terephthalates, a portion up to 30 mol % of the terephthalic acid to be used for preparation thereof may be replaced by 2,6-naphthalenedicarboxylic acid or isophthalic acid or mixtures thereof. Up to 70 mol %, preferably not more than 10 mol %, of the terephthalic acid may be replaced by aliphatic or cycloaliphatic dicarboxylic acids such as adipic acid, azelaic acid, sebacic acid, dodecanedioic acids or cyclohexanedicarboxylic acids.

Among the aliphatic dihydroxy compounds, preference is given to diols having 2 to 6 carbon atoms, especially ethane-1,2-diol, propane-1,3-diol, butane-1,4-diol, hexane-1,6-diol, hexane-1,4-diol, cyclohexane-1,4-diol, cyclohexane-1,4-dimethanol, neopentyl glycol or mixtures thereof. Particularly preferred polyalkylene terephthalates derive from alkanediols having 2 to 4 carbon atoms. Among these, preference is given especially to polyethylene terephthalate (PET), polypropylene terephthalate and polybutylene terephthalate (PBT) or mixtures thereof. Also preferred are PET and/or PBT which contain up to 1% by weight, preferably up to 0.75% by weight, of hexane-1,6-diol and/or 2-methylpentane-1,5-diol as further monomer units.

It is preferable when C₂-C₁₀ polyalkylene terephthalates to be used as polyester in accordance with the invention have a viscosity number determinable to ISO 1628 in the range from 50 to 220, preferably in the range from 80 to 160, by measurement in a 0.5% by weight solution in a 1:1 by weight phenol/o-dichlorobenzene mixture at 25 °C.

C₂-C₁₀ polyalkylene terephthalates to be used with preference in accordance with the invention as polyester preferably have a carboxyl end group content of up to 100 meq/kg polyester, more preferably a carboxyl end group content of up to 50 meq/kg polyester and especially preferably a carboxyl end group content of up to 40 meq/kg polyester. Such C₂-C₁₀ polyalkylene terephthalates can be prepared, for example, by the process according to DE-A 44 01 055. The carboxyl end group content is typically determined by titration processes, especially potentiometry.

Especially preferred C₂-C₁₀ polyalkylene terephthalates to be used as polyester are prepared with Ti catalysts. After polymerization these preferably have a residual Ti content of ≤250 ppm, more preferably of <200 ppm, most preferably of <150 ppm.

The polybutylene terephthalate (PBT) [CAS No. 24968-12-5] to be used with preference in accordance with the invention as C₂-C₁₀-polyalkylene terephthalate is prepared from terephthalic acid or the reactive derivatives thereof and butanediol by known methods (Kunststoff-Handbuch [Plastics Handbook], vol. VIII, p. 695-743, Karl Hanser Verlag, Munich 1973).

The PBT usable as polyester preferably contains at least 80 mol %, preferably at least 90 mol %, based on the dicarboxylic acid, of terephthalic acid radicals.

In one embodiment, PBT usable with preference in accordance with the invention as polyester may contain not only terephthalic acid radicals but also up to 20 mol % of radicals of other aromatic dicarboxylic acids having 8 to 14 carbon atoms or radicals of aliphatic dicarboxylic acids having 4 to 12 carbon atoms, especially radicals of phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid, cyclohexanedicarboxylic acid and 2,5-furandicarboxylic acid.

In one embodiment, PBT usable with preference in accordance with the invention as polyester may contain not only butanediol but also up to 20 mol % of other aliphatic diols having 3 to 12 carbon atoms or up to 20 mol % of cycloaliphatic diols having 6 to 21 carbon atoms, preferably radicals of propane-1,3-diol, 2-ethylpropane-1,3-diol, neopentyl glycol, pentane-1,5-diol, hexane-1,6-diol, 1,4-cyclohexanedimethanol, 3-methylpentane-2,4-diol, 2-methylpentane-2,4-diol, 2,2,4-trimethylpentane-1,3-diol, 2,2,4-trimethylpentane-1,5-diol, 2-ethylhexane-1,3-diol, 2,2-diethylpropane-1,3-diol, hexane-2,5-diol, 1,4-di(β-hydroxyethoxy)benzene, 2,2-bis(4-hydroxycyclohexyl)propane, 2,4-dihydroxy-1,1,3,3-tetramethylcyclobutane, 2,2-bis(3-β-hydroxyethoxyphenyl)propane and 2,2-bis(4-hydroxypropoxyphenyl)propane.

PBT to be used with preference as polyester has an intrinsic viscosity according to EN-ISO 1628/5 in the range from 40 to 170 cm³/g, more preferably in the range from 50 to 150 cm³/g, most preferably in the range from 65 to 135 cm³/g, in each case measured in phenol/o-dichlorobenzene (1:1 parts by weight) at 25 °C in an Ubbelohde viscometer. Intrinsic viscosity iV, also referred to as Staudinger Index or limiting viscosity, is proportional, according to the Mark-Houwink equation, to the average molecular mass, and is the extrapolation of the viscosity number VN for the case of vanishing polymer concentrations. It can be estimated from series of measurements or through the use of suitable approximation methods (e.g. Billmeyer). The VN [ml/g] is obtained from the measurement of the solution viscosity in a capillary viscometer, for example an Ubbelohde viscometer. Solution viscosity is a measure of the average molecular weight of a plastic. The determination is effected on dissolved polymer, with various solvents (m-cresol, tetrachloroethane, phenol, 1,2-dichlorobenzene, etc.) and concentrations being used. The viscosity number VN makes it possible to monitor the processing and performance characteristics of plastics. Thermal stress on the polymer, ageing processes or exposure to chemicals, weathering and light can be investigated by means of comparative measurements. In this regard see also: http://de.wikipedia.org/wiki/Viskosimetrie and http://de.wikipedia.org/wiki/Mark-Houwink-Gleichung.

PBT usable with preference as polyester may also be used in a mixture with other polymers. PBT blends usable in accordance with the invention are produced by compounding. During such a compounding operation, customary additives, especially demoulding agents or elastomers, may additionally be added to the melt to improve the properties of the blends.

PBT usable with preference in accordance with the invention is available from Envalior Deutschland GmbH, Düsseldorf, under the Pocan® B 1300 name.

### Polycarbonate for Use as Component a) Polyester

The polyester used with preference in accordance with the invention may also be at least one thermoplastic from the group of polycarbonates.

Polycarbonates usable with preference in accordance with the invention are homopolycarbonates or copolycarbonates based on bisphenols of general formula (III):

HO—Z—OH (III)

in which Z is a divalent organic radical which has 6 to 30 carbon atoms and contains one or more aromatic groups.

Preference is given to using, as polyester, at least one polycarbonate based on bisphenols of the formula (IIIa):

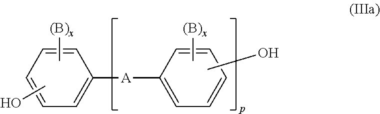

in which
A is a single bond or a radical from the group of C₁-C₅ alkylene, C₂-C₅ alkylidene, C₅-C₆ cycloalkylidene, —O—, —SO—, —CO—, —S—, —SO₂—, C₆-C₁₂ arylene, onto which further aromatic, optionally heteroatom-containing, rings may be condensed,
or A is a radical of the formula (IV) or (V):

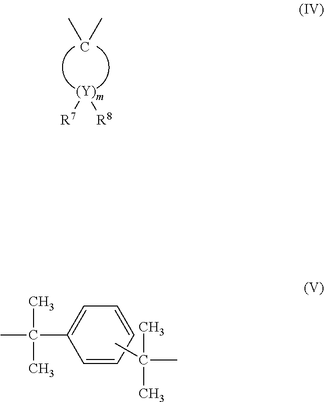

in which
R⁷ and R⁸ are individually selectable for each Y and independently of one another are hydrogen or C₁-C₆ alkyl, preferably hydrogen, methyl or ethyl,
B in each case is C₁-C₁₂ alkyl, preferably methyl, halogen, preferably chlorine and/or bromine,
x is independently at each occurrence 0, 1 or 2,
p is 1 or 0,
Y is carbon and
m is an integer from 4 to 7, preferably 4 or 5, with the proviso that on at least one Y (carbon atom), R⁷ and R⁸ are simultaneously alkyl.

In a preferred embodiment:
when m is 4, Y is —CR⁷R⁸—CR⁷R⁸—CR⁷R⁸—CR⁷R⁸—;
when m is 5, Y is —CR⁷R⁸—CR⁷R⁸—CR⁷R⁸—CR⁷R⁸—CR⁷R⁸—;
when m is 6, Y is —CR⁷R⁸—CR⁷R⁸—CR⁷R⁸—CR⁷R⁸—CR⁷R⁸—CR⁷R⁸—; and
when m is 7, Y is —CR⁷R⁸—CR⁷R⁸—CR⁷R⁸—CR⁷R⁸—CR⁷R⁸—CR⁷R⁸—CR⁷R⁸—.

Preferred bisphenols containing the general formula (IV) are bisphenols from the group of dihydroxydiphenyls, bis(hydroxyphenyl)alkanes, bis(hydroxyphenyl)cycloalkanes, indanebisphenols, bis(hydroxyphenyl) sulfides, bis(hydroxyphenyl) ethers, bis(hydroxyphenyl) ketones, bis(hydroxyphenyl) sulfones, bis(hydroxyphenyl) sulfoxides and α,α′-bis-(hydroxyphenyl)-diisopropylbenzenes.

Derivatives of the bisphenols mentioned that are preferably obtainable by alkylation or halogenation on the aromatic rings of the bisphenols mentioned are also bisphenols of the general formula (IV) that are usable with preference.

Particularly preferred bisphenols containing the general formula (IV) are hydroquinone, resorcinol, 4,4′-dihydroxydiphenyl, bis(4-hydroxyphenyl) sulfide, bis(4-hydroxyphenyl) sulfone, bis(3,5-dimethyl-4-hydroxyphenyl) methane, bis(3,5-dimethyl-4-hydroxyphenyl) sulfone, 1,1-bis(3,5-dimethyl-4-hydroxyphenyl)-p/m-diisopropylbenzene, 1,1-bis(4-hydroxyphenyl)-1-phenylethane, 1,1-bis(3,5-dimethyl-4-hydroxyphenyl)cyclohexane, 1,1-bis(4-hydroxyphenyl)-3-methylcyclohexane, 1,1-bis(4-hydroxyphenyl)-3,3-dimethylcyclohexane, 1,1-bis(4-hydroxyphenyl)-4-methylcyclohexane, 1,1-bis(4-hydroxyphenyl)-cyclohexane, 1,1-bis(4-hydroxyphenyl)-3,3,5-trimethylcyclohexane, 2,2-bis(3,5-dichloro-4-hydroxyphenyl)propane, 2,2-bis(3-methyl-4-hydroxyphenyl)propane, 2,2-bis(3,5-dimethyl-4-hydroxyphenyl)propane, 2,2-bis(4-hydroxyphenyl)propane (i.e. bisphenol A), 2,2-bis(3-chloro-4-hydroxyphenyl)propane, 2,2-bis(3,5-dibromo-4-hydroxyphenyl)propane, 2,4-bis(4-hydroxyphenyl)-2-methylbutane, 2,4-bis(3,5-dimethyl-4-hydroxyphenyl)-2-methylbutane, α,α′-bis(4-hydroxyphenyl)-o-diisopropylbenzene, α,α′-bis(4-hydroxyphenyl)-m-diisopropylbenzene (i.e. bisphenol M), α,α′-bis(4-hydroxyphenyl)-p-diisopropylbenzene and indanebisphenol.

The described bisphenols of the general formula (IV) can be prepared by processes known to those skilled in the art, preferably from the corresponding phenols and ketones.

The polycarbonates usable as polyester can also be prepared by known processes. Preferred processes for preparing polycarbonates are, for example, preparation from bisphenols with phosgene by the interfacial process, or from bisphenols with phosgene by the homogeneous phase process, what is called the pyridine process, or from bisphenols with carbonic esters by the melt transesterification process. The bisphenols mentioned and processes for preparation thereof are described, for example, in the monograph H. Schnell, “Chemistry and Physics of Polycarbonates”, Polymer Reviews, Volume 9, pp. 77-98, Interscience Publishers, New York, London, Sydney, 1964 and in U.S. Pat. No. 3,028,635, in U.S. Pat. No. 3,062,781, in U.S. Pat. No. 2,999,835, in U.S. Pat. No. 3,148,172, in U.S. Pat. No. 2,991,273, in U.S. Pat. No. 3,271,367, in U.S. Pat. No. 4,982,014, in U.S. Pat. No. 2,999,846, in DE-A 1 570 703, in DE-A 2 063 050, in DE-A 2 036 052, in DE-A 2 211 956, in DE-A 3 832 396, and in FR-A 1 561 518 and also in the Japanese laid-open specifications having application numbers JP-A 62039 1986, JP-A 62040 1986 and JP-A 105550 1986.

1,1-Bis(4-hydroxyphenyl)-3,3,5-trimethylcyclohexane and the preparation thereof is described, for example, in U.S. Pat. No. 4,982,014.

Indanebisphenols and the preparation thereof are described, for example, in U.S. Pat. No. 3,288,864, in JP-A 60 035 150 and in U.S. Pat. No. 4,334,106. Indanebisphenols can be prepared, for example, from isopropenylphenol or derivatives thereof or from dimers of isopropenylphenol or derivatives thereof in the presence of a Friedel-Craft catalyst in organic solvents.

The melt transesterification process is described in H. Schnell, “Chemistry and Physics of Polycarbonates”, Polymer Reviews, Volume 9, pages 44 to 51, Interscience Publishers, New York, London, Sydney, 1964 and in DE-A 1 031 512.

In the production of polycarbonate, preference is given to using raw materials and auxiliaries having a low level of impurities. Especially in the case of production by the melt transesterification process, the bisphenols used and the carbonic acid derivatives used are ideally to be very substantially free of alkali metal ions and alkaline earth metal ions. Raw materials having such a degree of purity are obtainable for example by recrystallizing, washing or distilling the carbonic acid derivatives, in particular carbonate esters, and the bisphenols.

Polycarbonates usable with preference in accordance with the invention as polyester preferably have a weight-average molar mass M_{w} in the range from 10 000 to 200 000 g/mol determinable by ultracentrifugation (see K. Schilling, Analytische Ultrazentrifugation [Analytical Ultracentrifugation], Nanolytics GmbH, Dallgow, pages 1-15) or scattered light measurement according to DIN EN ISO 16014-5:2012-10. More preferably, the polycarbonates to be used have a weight-average molar mass in the range from 12 000 to 80 000 g/mol, especially preferably a weight-average molar mass in the range from 20 000 to 35 000 g/mol.

The average molar mass of polycarbonates usable with preference in accordance with the invention as polyester can preferably be adjusted in a known manner using an appropriate amount of chain terminators. The chain terminators may be used individually or as a mixture of different chain terminators.

Preferred chain terminators include both monophenols and monocarboxylic acids. Preferred monophenols are phenol, p-chlorophenol, p-tert-butylphenol, cumylphenol or 2,4,6-tribromophenol, and also alkylphenols, long-chain especially 4-(1,1,3,3-tetramethylbutyl)phenol or monoalkylphenols/dialkylphenols having a total of 8 to 20 carbon atoms in the alkyl substituents, especially 3,5-di-tert-butylphenol, p-tert-octylphenol, p-dodecylphenol, 2-(3,5-dimethylheptyl)phenol or 4-(3,5-dimethylheptyl)phenol. Preferred monocarboxylic acids are benzoic acid, alkylbenzoic acids or halobenzoic acids.

Particularly preferred chain terminators are phenol, p-tert-butylphenol, 4-(1,1,3,3-tetramethylbutyl)phenol or cumylphenol.

The amount of chain terminators to be used is preferably in the range from 0.25 to 10 mol % based on the sum of the bisphenols employed in each case.

Polycarbonates usable with preference in accordance with the invention as polyester may be branched in a known manner, preferably by the incorporation of branching agents that are trifunctional or more than trifunctional. Preferred branching agents have three or more than three phenolic groups or three or more than three carboxylic acid groups.

Particularly preferred branching agents are phloroglucinol, 4,6-dimethyl-2,4,6-tri-(4-hydroxyphenyl)hept-2-ene, 4,6-dimethyl-2,4,6-tri-(4-hydroxyphenyl)heptane, 1,3,5-tri-(4-hydroxyphenyl)benzene, 1,1,1-tris-(4-hydroxyphenyl)ethane, tri(4-hydroxyphenyl)phenylmethane, 2,2-bis[4,4-bis(4-hydroxyphenyl)cyclohexyl]propane, 2,4-bis(4-hydroxyphenylisopropyl)phenol, 2,6-bis(2-hydroxy-5′-methylbenzyl)-4-methylphenol, 2-(4-hydroxyphenyl)-2-(2,4-dihydroxyphenyl)propane, hexa(4-(4-hydroxyphenylisopropyl)phenyl) terephthalate, tetra(4-hydroxyphenyl) methane, tetra(4-(4-hydroxyphenylisopropyl) phenoxy) methane and 1,4-bis(4′,4″-dihydroxytriphenyl)methylbenzene, 2,4-dihydroxybenzoic acid, trimesic acid, cyanuric chloride, 3,3-bis(3-methyl-4-hydroxyphenyl)-2-oxo-2,3-dihydroindole, trimesyl trichloride or α,α′,α″-tris-(4-hydroxyphenol)-1,3,5-triisopropylbenzene.

Very particularly preferred branching agents are 1,1,1-tris(4-hydroxyphenyl)ethane or 3,3-bis(3-methyl-4-hydroxyphenyl)-2-oxo-2,3-dihydroindole.

The amount of branching agents to be employed is preferably in the range from 0.05 mol % to 2 mol % based on the moles of bisphenols employed.

In the case of preparation of a polycarbonate by the interfacial process, the branching agents are preferably included in an initially charged aqueous alkaline phase with the bisphenols and the chain terminators or added together with the carbonic acid derivatives as a solution in an organic solvent. If the transesterification process is used, the branching agents are preferably metered in together with the dihydroxyaromatics or bisphenols.

Catalysts used with preference in the preparation of polycarbonates usable with preference in accordance with the invention as polyester by the melt transesterification process are ammonium salts and phosphonium salts, as described, for example, in U.S. Pat. No. 3,442,864, JP-A-14742/72, U.S. Pat. No. 5,399,659 or DE-A 19 539 290.

In a preferred embodiment, it is also possible to use copolycarbonates as polyester. Copolycarbonates in the context of the invention are especially polydiorganosiloxane-polycarbonate block copolymers having a weight-average molar mass M_{w} preferably in the range from 10 000 to 200 000 g/mol, more preferably in the range from 20 000 to 80 000 g/mol, determined by gel chromatography according to DIN EN ISO 16014-5:2012-10 after prior calibration by scattered light measurement or ultracentrifugation. The content of aromatic carbonate structural units in the polydiorganosiloxane-polycarbonate block copolymers is preferably in the range from 75% to 97.5% by weight, more preferably in the range from 85% to 97% by weight. The content of polydiorganosiloxane structural units in the polydiorganosiloxane-polycarbonate block copolymers is preferably in the range from 25% to 2.5% by weight, more preferably in the range from 15% to 3% by weight. The polydiorganosiloxane-polycarbonate block copolymers can preferably be prepared from polydiorganosiloxanes containing α,ω-bishydroxyaryloxy end groups and having an average degree of polymerization Pₙ in the range from 5 to 100, more preferably having an average degree of polymerization Pₙ in the range from 20 to 80.

Polycarbonates to be used with particular preference as polyester include the homopolycarbonate based on bisphenol A, the homopolycarbonate based on 1,1-bis(4-hydroxyphenyl)-3,3,5-trimethylcyclohexane, and the copolycarbonates based on the two monomers bisphenol A and 1,1-bis(4-hydroxyphenyl)-3,3,5-trimethylcyclohexane (=bisphenol TMC). Polycarbonates usable with preference in accordance with the invention as polyester are obtainable, for example, from Covestro AG, Leverkusen under the Makrolon® brand.

In one embodiment, the polycarbonates usable as polyester may have customary additives, especially demoulding agents, added thereto in the melt or applied to the surface. The polycarbonates for use as polyester preferably already contain demoulding agents before subsequent compounding with the other components, where the person skilled in the art understands compounding to mean the plastics industry term, synonymous with plastics processing, which describes the process of finishing plastics by addition of admixtures (fillers, additives etc.) for controlled optimization of the profiles of properties. See: https://de.wikipedia.org/wiki/Compoundierung. Compounding is preferably effected in extruders, more preferably in co-rotating twin-screw extruders, counter-rotating twin-screw extruders, planetary screw extruders or co-compounders, and comprises the process operations of conveying, melting, dispersing, mixing, degassing and pressure buildup.

However, in a preferred embodiment, the polyester used may also be blends of polycarbonate and polyalkylene terephthalates, which are likewise sold by Covestro AG under the Makroblend® brand. These are preferably PC-PET blends, PC-PBT blends or PC-PCT-G blends, where PC stands for polycarbonate, PET for polyethylene terephthalate, PBT for polybutylene terephthalate and PCT for polycyclohexylene dimethylene terephthalate.

### b) Flame Retardants

In order to achieve fire protection classifications such as UL 94 V0 or GWFI 960 °C (Glow Wire Flammability Index), only small doses of at least one flame retardant of component b) are often needed.

Phosphinic salts to be used as component b) with preference in accordance with the invention are dialkylphosphinic salts to be selected from the group of aluminium methylethylphosphinate, aluminium trisdiethylphosphinate, aluminium isopropylisobutylphosphinate, aluminium isopropyl-tert-butylphosphinate, aluminium diisobutylphosphinate, aluminium trismethylethylphosphinate, zinc bisdiethylphosphinate, zinc bismethylethylphosphinate and mixtures thereof.

Particular preference is given to using aluminium trisdiethylphosphinate or zinc bisdiethylphosphinate. Aluminium trisdiethylphosphinate is especially preferred. These usually colourless flame retardants are sold by Clariant International Ltd, Muttenz, Switzerland under the Exolit® brand, for example aluminium trisdiethylphosphinate (DEPAL) in pure form as Exolit® OP1240 or zinc bisdiethylphosphinate as Exolit® OP950. Aluminium trisdiethylphosphinate, DEPAL, which is especially preferably to be used as component b) in the context of the present application was first described by Clariant GmbH, Frankfurt am Main, in WO 99/28327 A1 and recorded in the registry database under CAS No. 225789-38-8 and the name “Phosphinic acid, P,P-diethyl-aluminum salt (3:1)”.

### c) Flame Retardant Synergist

The flame retardant effect of a flame retardant can be additionally improved by use of synergists, in that they shorten the fire duration or afterburn times, or prevent dripping of the polymer that has melted or is burning in the heat of the fire. For example, KR 890 004 333 B1 informs the skilled person of the use of antimony trioxide (Sb₂O₃) as synergist in combination with halogen-containing flame retardants.

According to the invention, the flame retardant of component b) is used together with c) at least one flame retardant synergist to be selected from melamine polyphosphate (CAS No. 1312753-42-6 or 218768-84-4) and aluminium phosphonate (CAS No. 2278203-39-5). Melamine polyphosphate is available as Melapur® 200/70 from BASF SE, Ludwigshafen, Germany. Aluminium phosphonate is obtainable as secondary aluminium phosphonate of the formula Al₂(HPO₃)₃·(H₂O)_{q} with q in the range from 0 to 4, according to example 2 of WO 2013/083247 A1.

Particularly preferred combinations of components b) and c) are those in the form of aluminium trisdiethylphosphinate (DEPAL) with melamine polyphosphate and aluminium trisdiethylphosphinate (DEPAL) with aluminium phosphonate.

In the context of the present invention, it has additionally been found that zinc bisdiethylphosphinate or zinc bismethylethylphosphinate does not necessarily require a flame retardant synergist. The present invention therefore relates, in a preferred embodiment, to plastic products made from polymer compositions comprising a) at least one polyester, b) at least one flame retardant from zinc bisdiethylphosphinate and zinc bismethylethylphosphinate, and d) as colourant the isomer mixture of 9,9′-oxybis-12H-phthaloperin-12-one, 9,10-oxybis-12H-phthaloperin-12-one and 10,10′-oxybis-12H-phthaloperin-12-one.

Flame retardants synergists to be used as component c) are likewise sold under the Exolit® brand in the form of finished mixtures with the flame retardants of component b), for example, by Clariant International Ltd, Muttenz, Switzerland. The following are mentioned here by way of example: Exolit® OP1311, Exolit® OP1314, Exolit® OP1316, Exolit® OP1400, Exolit® OP1402, Exolit® OP1466 or Exolit® OP1260.

### Further Components

The filler or reinforcer for additional use in the preferred embodiment as component e) can also be used in the form of mixtures of two or more different fillers and/or reinforcers.

Preference is given to using at least one filler or reinforcer from the group of carbon fibres [CAS No. 7440-44-0], glass beads or solid or hollow glass beads, or glass fibres, or ground glass, amorphous quartz glass, aluminium borosilicate glass having an alkali content of 1% (E glass) [CAS No. 65997-17-3], amorphous silica [CAS No. 7631-86-9], quartz flour [CAS No. 14808-60-7], calcium silicate [CAS No. 1344-95-2], calcium metasilicate [CAS No. 10101-39-0], magnesium carbonate [CAS No. 546-93-0], kaolin [CAS No. 1332-58-7], calcined kaolin [CAS No. 92704-41-1], chalk [CAS No. 1317-65-3], kyanite [CAS No. 1302-76-7], powdered or ground quartz [CAS No. 14808-60-7], mica [CAS No. 1318-94-1], phlogopite [CAS No. 12251-00-2], barium sulfate [CAS No. 7727-43-7], feldspar [CAS No. 68476-25-5], wollastonite [CAS No. 13983-17-0], montmorillonite [CAS No. 67479-91-8], pseudoboehmite of the formula AlO(OH), magnesium carbonate [CAS No. 12125-28-9] and talc [CAS No. 14807-96-6].

Particularly preferred fibrous fillers or reinforcers include glass fibres and wollastonite, with very particular preference for glass fibres. With regard to the glass fibres, a person skilled in the art will distinguish between chopped fibres, also called short fibres, having a length in the range from 0.1 to 1 mm, long fibres having a length in the range from 1 to 50 mm, and continuous fibres having a length L >50 mm. Short fibres are preferably used in injection moulding methodology and may be processed directly with an extruder. Long fibres can likewise still be processed in extruders. Said fibres are widely used in fibre spraying. Long fibres are frequently added to thermosets as a filler. Continuous fibres are used in the form of rovings or weaves in fibre-reinforced plastics. Articles of manufacture comprising continuous fibres achieve the highest stiffness and strength values. Also available are ground glass fibres, the length of which after grinding is typically in the range from 70 to 200 μm.

Glass fibres to be used with preference in accordance with the invention as filler or reinforcer are chopped long glass fibres having an average starting length to be determined by laser diffraction-particle size analysis (laser granulometry/laser diffractometry) according to ISO 13320 in the range from 1 to 50 mm, more preferably in the range from 1 to 10 mm, most preferably in the range from 2 to 7 mm. With regard to laser diffraction particle size determination/laser diffractometry according to standard ISO 13320 see:
https://de.wikipedia.org/wiki/Laserbeugungs-Partikelgr%C3%B6%C3%9Fenanalyse

The glass fibres may, as a result of the processing to give the moulding material (compounding) or the article of manufacture, especially in the injection moulding process, have a lower d90 or d50 value in the moulding material or in the article of manufacture than the glass fibres originally used. Thus, the arithmetic average of the glass fibre length after processing is often only in the range from 150 μm to 300 μm, and therefore the lengths, widths and diameters for fillers and reinforcers, especially in respect of glass fibres, given in the present description relate to the state before any processing, in particular before compounding or before processing, especially in injection moulding.

Preferred glass fibres usable as fillers or reinforcers have an average fibre diameter determinable by laser diffractometry according to ISO 13320 in the range from 7 to 18 μm, more preferably in the range from 9 to 15 μm.

In a preferred embodiment, the glass fibres usable with preference as fillers or reinforcers are modified with a suitable size system or an adhesion promoter (system). Preference is given to using a size system or a silane-based adhesion promoter.

The invention therefore preferably relates to plastic products or the precursor thereof, made from polymer compositions having a colour distance ΔE<20 of the L*a*b* coordinates from a colour number beginning with “2” in the RAL colour chart, comprising a) at least one polyester and the abovementioned components b) the at least one flame retardant, c) the at least one flame retardant synergist, d) the at least one colourant and e) glass fibres, preferably chopped long glass fibres having an average original length in the range of 1 to 50 mm to be determined by laser diffraction particle size analysis (laser granulometric measurement or laser diffraction) according to ISO 13320. Preferably, the average original length of the cut long glass fibres to be determined according to ISO 13320 is in the range of 1 to 10 mm, very particularly preferably in the range of 2 to 7 mm.

Preference is given to using, in the polymer compositions, for every 100 parts by mass of polyester, 1 to 150 parts by mass, preferably 5 to 80 parts by mass, more preferably 10 to 50 parts by mass, of chopped long glass fibres.

The chopped long glass fibres preferably have an average fibre diameter determinable by laser diffractometry according to ISO 13320 in the range from 7 to 18 μm, more preferably in the range from 9 to 15 μm.

The polyester used is preferably at least one C₂-C₁₀ polyalkylene terephthalate, especially preferably polybutylene terephthalate (PBT).

### Additives

Under the premise of obtaining high laser transmittance, the polymer compositions according to the invention or plastic products, in a preferred embodiment, in addition to components a), b), c), d) and e) or instead of e), comprise at least one f) additive other than the aforementioned components. Additives f) usable with preference include antioxidants, (thermal) stabilizers, UV stabilizers, gamma ray stabilizers, components for reducing water absorption or hydrolysis stabilizers, antistats, emulsifiers, nucleating agents, plasticizers, processing auxiliaries, impact modifiers, lubricants and/or demoulding agents, components for reducing water absorption, flow auxiliaries or elastomer modifiers, chain-extending additives and colourants other than the isomer mixture in the form of 9,9′-oxybis-12H-phthaloperin-12-one, 9,10-oxybis-12H-phthaloperin-12-one and 10,10′-oxybis-12H-phthaloperin-12-one. The additives may be used alone or in a mixture, or in the form of masterbatches.

Preferred (thermal) stabilizers as additives include sterically hindered phenols, in particular those containing at least one 2,6-di-tert-butylphenyl group and/or 2-tert-butyl-6-methylphenyl group, and also phosphites, hypophosphites, especially sodium hypophosphite NaH₂PO₂, hydroquinones, aromatic secondary amines, substituted resorcinols, salicylates, benzotriazoles and benzophenones, 3,3′-thiodipropionic esters and variously substituted representatives of these groups or mixtures thereof. Further stabilizers in the context of the present invention are zinc oxide, zinc borate and calcium or zinc (hydroxy) stannates. The (thermal) stabilizers usable as additives are preferably used in amounts of 0.01 to 5 parts by mass, more preferably 0.05 to 3 parts by mass, based in each case on 100 parts by mass of polyester.

UV stabilizers usable as additives preferably include substituted resorcinols, salicylates, benzotriazoles and benzophenones, HALS derivatives (“Hindered Amine Light Stabilizers”) containing at least one 2,2,6,6-tetramethyl-4-piperidyl unit, or benzophenones. The UV stabilizers usable as additives are preferably used in amounts of 0.01 to 2 parts by mass, more preferably 0.1 to 1 parts by mass, based in each case on 100 parts by mass of polyester.

Colourants other than the isomer mixture in the form of 9,9′-oxybis-12H-phthaloperin-12-one, 9,10-oxybis-12H-phthaloperin-12-one and 10,10′-oxybis-12H-phthaloperin-12-one that are usable as additives preferably include inorganic pigments, in particular ultramarine blue, bismuth vanadate, iron oxide, titanium dioxide, zinc sulfide, zinc-titanium-zinc oxides [CAS No. 923954-49-8], and also organic dyes, preferably phthalocyanines, quinacridones, benzimidazoles, in particular nickel 2-hydroxynapthylbenzimidazole [CAS No. 42844-93-9] and/or pyrimidine-azo-benzimidazole [CAS No. 72102-84-2] and/or Pigment Yellow 192 [CAS No. 56279-27-7], and also perylenes, anthraquinones, 1,3-dihydro-5,6-bis(((2-hydroxy-1-naphthyl)methylene)amino-2H-benzimidazol-2-onato(2-)-N5,N6,O5,O6) nickel, in particular C.I. Solvent Yellow 163 [CAS No. 13676-91-0], this enumeration being nonexhaustive. In one embodiment, colourants used are also carbon black or nigrosin, with loss of the laser-transmitting capacity for laser-absorbing plastic products.

Nucleating agents usable as additives preferably include sodium phenylphosphinate or calcium phenylphosphinate, aluminium oxide or silicon dioxide, and even more preferably talc, this enumeration being nonexhaustive.

Plasticizers usable with preference as additives include dioctyl phthalate, dibenzyl phthalate, butyl benzyl phthalate, hydrocarbon oils or N-(n-butyl)benzenesulfonamide.

Elastomer modifiers usable with preference as additives include one or more graft polymers of
E.1 5% to 95% by weight, preferably 30% to 90% by weight, of at least one vinyl monomer and
E.2 95% to 5% by weight, preferably 70% to 10% by weight, of one or more graft substrates having glass transition temperatures <10 °C, preferably <0 °C, more preferably <−20 °C, where the percentages by weight are based on 100% by weight of elastomer modifier. The graft substrate E.2 generally has a median particle size d50 value determinable by laser diffractometry according to ISO 13320 of 0.05 to 10 μm, preferably 0.1 to 5 μm, more preferably 0.2 to 1 μm.

Monomers E.1 are preferably mixtures of
E.1.1 50% to 99% by weight of vinylaromatics and/or ring-substituted vinylaromatics, especially styrene, α-methylstyrene, p-methylstyrene, p-chlorostyrene, and/or (C₁-C₈)-alkyl methacrylates, especially methyl methacrylate, ethyl methacrylate and
E.1.2 1% to 50% by weight of vinyl cyanides, especially unsaturated nitriles such as acrylonitrile and methacrylonitrile and/or (C₁-C₈)-alkyl (meth)acrylates, especially methyl methacrylate, glycidyl methacrylate, n-butyl acrylate, t-butyl acrylate, and/or derivatives, especially anhydrides and imides of unsaturated carboxylic acids, especially maleic anhydride or N-phenylmaleimide, where the percentages by weight are based on 100% by weight of elastomer modifier.

Preferred monomers E.1.1 are to be selected from at least one of the monomers styrene, a-methylstyrene and methyl methacrylate; preferred monomers E. 1.2 are selected from at least one of the monomers acrylonitrile, maleic anhydride, glycidyl methacrylate and methyl methacrylate. Particularly preferred monomers are E.1.1 styrene and E.1.2 acrylonitrile.

Graft substrates E.2 suitable for the graft polymers usable in the elastomer modifiers include, for example, diene rubbers, EPDM rubbers, i.e. those based on ethylene/propylene and optionally diene, and also acrylate, polyurethane, silicone, chloroprene and ethylene/vinyl acetate rubbers. EPDM is ethylene-propylene-diene rubber.

Preferred graft substrates E.2 are diene rubbers, in particular based on butadiene, isoprene, etc., or mixtures of diene rubbers or copolymers of diene rubbers or mixtures thereof with further copolymerizable monomers, especially of E.1.1 and E.1.2, with the proviso that the glass transition temperature of component E.2 is <10 °C, preferably <0 °C, more preferably <−10 °C.

Lubricants and/or demoulding agents usable as additives preferably include long-chain fatty acids, especially stearic acid or behenic acid, salts thereof, especially calcium stearate or zinc stearate, and the ester derivatives thereof, especially those based on pentaerythritol, especially fatty acid esters of pentaerythritol or amide derivatives, especially ethylenebisstearylamide, montan waxes and low molecular weight polyethylene or polypropylene waxes. Montan waxes in the context of the present invention are mixtures of straight-chain saturated carboxylic acids having chain lengths of 28 to 32 carbon atoms.

### Process

The invention also relates to a process for producing plastic products, especially injection-moulded plastic products, by mixing
a) at least one polyester,
b) at least one flame retardant composed of at least one phosphinic salt of the formula (I) and/or
at least one diphosphinic salt of the formula (II) and/or polymers thereof

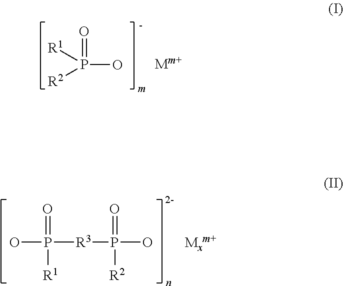

in which
R¹, R² are the same or different and are a linear or branched C₁-C₆-alkyl and/or C₆-C₁₄-aryl,
   R³ is linear or branched C₁-C₁₀-alkylene, C₆-C₁₀-arylene or C₁-C₆-alkyl-C₆-C₁₀-arylene or C₆-C₁₀-aryl-C₁-C₆-alkylene,
   M is aluminium or zinc,
   m is an integer from 1 to 4;
   n is an integer from 1 to 3 and
   x is 1 or 2,
   where n, x and m in formula (II) may at the same time assume only such integer values that the diphosphinic salt of the formula (II) as a whole is uncharged,
c) at least one flame retardant synergist to be selected from melamine polyphosphate and aluminium phosphonate, and
d) at least one colourant in the form of the isomer mixture of 9,9′-oxybis-12H-phthaloperin-12-one, 9,10-oxybis-12H-phthaloperin-12-one and 10,10′-oxybis-12H-phthaloperin-12-one
to give polymer compositions, extruding to strands, cooling until pelletizable, drying and pelletizing, and then processing the polymer compositions further by injection moulding, including the special methods of gas injection technology (GIT), water injection technology (WIT) or projectile injection technology (PIT), by extrusion methods, including profile extrusion, or by blow moulding.

Preference is given to using, in the process according to the invention, at least one flame retardant composed of at least one phosphinic salt of the formula (I)

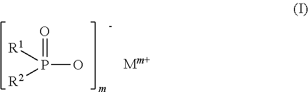

in which
R¹, R² are the same or different and are a linear or branched C₁-C₆-alkyl,
   M is aluminium or zinc and
   m is an integer from 1 to 4.

Preferably, in the process according to the invention,
a) for every 100 parts by mass of the at least one polyester, preferably the at least one C₂-C₁₀ polyalkylene terephthalate or polycarbonate,
b) 2 to 100 parts by mass, preferably 5 to 60 parts by mass, more preferably 7 to 40 parts by mass, especially preferably 8 to 30 parts by mass of the at least one flame retardant b),
c) 0.2 to 50 parts by mass, preferably 0.5 to 40 parts by mass, more preferably 0.75 to 35 parts by mass, of the at least one flame retardant synergist c) and
d) 0.01 to 5 parts by mass of the at least one colourant in the form of the isomer mixture of 9,9′-oxybis-12H-phthaloperin-12-one, 9,10-oxybis-12H-phthaloperin-12-one and 10,10′-oxybis-12H-phthaloperin-12-one.

Preferably, the plastic products obtainable by the process according to the invention too have a colour distance ΔE<10 of the L*a*b* coordinates from a colour number beginning with “2” in the RAL colour chart, more preferably a colour distance ΔE<5, to be determined according to DIN 5033 (1979), of the L*a*b* coordinates from a colour number beginning with “2” in the RAL colour chart according to EN ISO 11664-4.

In particular, the polyester used in the process according to the invention is preferably polybutylene terephthalate.

The invention even more preferably relates to a process in which, in addition to components a) and b) and c) and d), e) glass fibres are also used, having an average starting length determinable by laser diffraction particle size analysis (laser granulometry/laser diffractometry) according to ISO 13320 in the range from 1 to 50 mm, more preferably in the range from 1 to 10 mm, even more preferably in the range from 2 to 7 mm.

Preferably, in the process according to the invention, 1 to 150 parts by mass, more preferably 5 to 80 parts by mass, even more preferably 10 to 50 parts by mass, of glass fibres are used, based on 100 parts by mass of polyester.

In the process according to the invention too, the glass fibres especially preferably have an average fibre diameter determinable by laser diffractometry according to ISO 13320 in the range from 7 to 18 μm, more preferably in the range from 9 to 15 μm.

The invention more preferably relates to a process for producing plastic products in the form of laser-transparent, orange and flame-retardant products or joining partners for further processing in laser transmission welding in the wavelength range from 800 nm to 1200 nm. It is preferable to employ an Nd:YAG laser (1064 nm) or a high-performance diode laser (800-1000 nm) in laser transmission welding.

For the sake of clarity, it should be noted that the scope of the present invention encompasses all definitions and parameters cited in general in the context of the electromobility components or cited in ranges of preference in any desired combinations of the processes according to the invention.

### Uses

The invention preferably relates to the use of the colourant containing the isomer mixture of 9,9′-oxybis-12H-phthaloperin-12-one, 9,10-oxybis-12H-phthaloperin-12-one and 10,10′-oxybis-12H-phthaloperin-12-one for production of flame-retardant plastic products when said plastic products comprise
a) at least one polyester,
b) at least one flame retardant composed of at least one phosphinic salt of the formula (I) and/or at least one diphosphinic salt of the formula (II) and/or polymers thereof

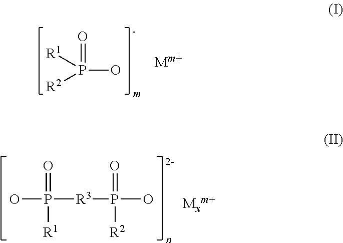

in which
R¹, R² are the same or different and are a linear or branched C₁-C₆-alkyl and/or C₆-C₁₄-aryl,
   R³ is linear or branched C₁-C₁₀-alkylene, C₆-C₁₀-arylene or C₁-C₆-alkyl-C₆-C₁₀-arylene or C₆-C₁₀-aryl-C₁-C₆-alkylene,
   M is aluminium or zinc,
   m is an integer from 1 to 4;
   n is an integer from 1 to 3 and
   x is 1 or 2,
   where n, x and m in formula (II) may at the same time assume only such integer values that the diphosphinic salt of the formula (II) as a whole is uncharged,
c) at least one flame retardant synergist to be selected from melamine polyphosphate and aluminium phosphonate.

It is preferable to use, in the context of the use according to the invention, at least one flame retardant of at least one phosphinic acid salt of the formula (I)

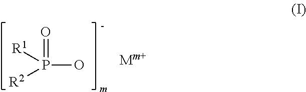

in which
R¹, R² are the same or different and are a linear or branched C₁-C₆-alkyl,
   M is aluminium or zinc and
   m is an integer from 1 to 4.

Also preferably used, in the context of the use according to the invention, for every 100 parts by mass of a) the at least one polyester,
2 to 100 parts by mass, preferably 5 to 60 parts by mass, more preferably 7 to 40 parts by mass, especially preferably 8 to 30 parts by mass, of b) the at least one flame retardant,
0.2 to 50 parts by mass, preferably 0.5 to 40 parts by mass, more preferably 0.75 to 35 parts by mass, of c) the at least one flame retardant synergist
and 0.01 to 5 parts by mass of d) the at least one colourant comprising the isomer mixture of 9,9′-oxybis-12H-phthaloperin-12-one, 9,10-oxybis-12H-phthaloperin-12-one and 10,10′-oxybis-12H-phthaloperin-12-one.

Preferred polyesters, in the context of the use according to the invention, are C₂-C₁₀ polyalkylene terephthalates or polycarbonates, in particular polybutylene terephthalate.

In a preferred embodiment, also in the context of the use according to the invention, the plastic products in addition to components a) and b) and c) and d), contain e) glass fibres which are also used, having an average starting length determinable by laser diffraction particle size analysis (laser granulometry/laser diffractometry) according to ISO 13320 in the range from 1 to 50 mm, more preferably in the range from 1 to 10 mm, even more preferably in the range from 2 to 7 mm.

Preferably, also in the context of the use according to the invention, 1 to 150 parts by mass, more preferably 5 to 80 parts by mass, even more preferably 10 to 50 parts by mass, of glass fibres are used, based on 100 parts by mass of polyester.

Also in the context of the use according to the invention, the glass fibres especially preferably have an average fibre diameter determinable by laser diffractometry according to ISO 13320 in the range from 7 to 18 μm, more preferably in the range from 9 to 15 μm.

Preferably, the invention relates to the use of the colourant in the form of the isomer mixture of 9,9′-oxybis-12H-phthaloperin-12-one, 9,10-oxybis-12H-phthaloperin-12-one and 10,10′-oxybis-12H-phthaloperin-12-one for production of plastic products and the polymer compositions required for production thereof with a colour distance ΔE<20 of the L*a*b* coordinates from a colour number beginning with “2” in the RAL colour chart when these comprise a) at least one polyester and the abovementioned components b) the at least one flame retardant and c) the at least one flame retardant synergist.

More preferably, the invention relates to the use of the colourant in the form of the isomer mixture of 9,9′-oxybis-12H-phthaloperin-12-one, 9,10-oxybis-12H-phthaloperin-12-one and 10,10′-oxybis-12H-phthaloperin-12-one for production of plastic products and the polymer compositions required for production thereof with a colour distance ΔE<20, to be determined according to DIN 5033 (1979), of the L*a*b* coordinates from a colour number beginning with “2” in the RAL colour chart according to EN-ISO 11664-4 when these comprise a) at least one polyester and the abovementioned components b) the at least one flame retardant, c) the at least one flame retardant synergist and e) glass fibres.

Preferably, the colourant in the form of the isomer mixture of 9,9′-oxybis-12H-phthaloperin-12-one, 9,10-oxybis-12H-phthaloperin-12-one and 10,10′-oxybis-12H-phthaloperin-12-one in plastic products is used in order to obtain laser-transparent, orange, flame-retardant products or joining partners, more preferably in order to use them in laser transmission welding in the wavelength range of 800 nm to 1200 nm. Preferably, in the context of this use, an Nd:YAG laser (1064 nm) or a high-performance diode laser (800-1000 nm) is employed.

The plastic products are preferably injection-moulded plastic products; more preferably, the plastic products or injection-moulded plastic products, but also the laser-transparent, orange, flame-retardant products or joining partners, are components for the electric drivetrains of motor vehicles, called electromobility components.

For the sake of clarity, it should be noted that the scope of the claimed use includes all the definitions and parameters listed in general in the context of the above-mentioned plastic products or methods according to the invention, or in areas of preference, in any desired combinations.

It will be understood that the specification and examples are illustrative but not limitative of the present invention and that other embodiments within the spirit and scope of the invention will suggest themselves to those skilled in the art.

### EXAMPLES

To demonstrate the improvements in properties described in accordance with the invention, corresponding polyester-based polymer compositions were first made up by compounding. To this end, the individual components were mixed in a twin-screw extruder (Leistritz LSM 30-34 from Leistritz AG (Nuremberg, Germany)) at temperatures between 270 °C and 300 °C, extruded as a strand, cooled until pelletizable and pelletized. After drying (generally for two days at 80 °C in the vacuum drying cabinet), the pellets were processed by injection moulding at temperatures in the range from 270 to 290 °C to give standard test specimens for the respective tests.

### Starting Materials:

Component a) polybutylene terephthalate (Pocan® B 1300, Envalior Deutschland GmbH, Düsseldorf, Germany)

### Component b) & Component c)

Exolit® OP 1311 from Clariant International Ltd., Muttenz, Switzerland, containing aluminium trisdiethylphosphinate (CAS No. 225789-38-8) and melamine polyphosphate (CAS No. 1312753-42-6)
   Component b) & Component c′)
Exolit® OP 1400 from Clariant International Ltd., Muttenz, Switzerland, containing aluminium trisdiethylphosphinate (CAS No. 225789-38-8) and aluminium phosphonate (CAS No. 2278203-39-5)
Component d′ colourant according to WO 2020/187704 A1, i.e. 10,10′-oxybis-12H-phthaloperin-12-one [CAS No. 203576-97-0], from Angene International Limited, London
Component d) colourant having a median particle size d50 determinable by laser diffractometry according to ISO 13320 in the region of 5 μm in the form of the isomers 9,9′-oxybis-12H-phthaloperin-12-one, 9,10-oxybis-12H-phthaloperin-12-one and 10,10′-oxybis-12H-phthaloperin-12-one in a ratio of 1:1.2:1, prepared according to the following synthesis specification:

### Synthesis Specification for Component d)

### Preparation of the colourant in the form of the isomers 9,9′-oxybis-12H-phthaloperin-12-one, 9,10-oxybis-12H-phthaloperin-12-one and 10,10′-oxybis-12H-phthaloperin-12-one in a Ratio of 1:1.2:1

300 g of phenol was melted at a temperature of 60 °C. To the latter were added 45 g (285 mmol) of 1,8-diaminonaphthalene and 3.1 g of 2,6-lutidine (28.5 mmol), and the mixture was stirred for 30 minutes. Then 45 g (145 mmol) of 4,4-oxydiphthalic anhydride was introduced and the reaction mixture was stirred for a further 30 minutes. Thereafter, the reaction mixture was heated to 175 °C and held at that temperature for 10 hours, and the resultant water of reaction was distilled off. 295 g of methanol was then added to the reaction mixture at a temperature of 175 °C, and the temperature of the reaction mixture was lowered to 30 °C over one hour. The reaction product was isolated on a suction filter and subsequently stirred in 300 g of phenol at 175 °C for 45 minutes. 295 g of methanol was then added at a temperature of 175 °C, and the temperature of the reaction mixture was lowered to 30 °C over three hours. The reaction product was isolated on a suction filter and washed first with 440 g of methanol and then with 800 g of water and dried in a vacuum drying cabinet at 80 °C and 150 mbar. The isomer distribution of the dye was determined as 1:1.2:1, and the median particle size d50 as 5 μm.

TABLE 2

| | | Comp. 1 | Comp. 2 | Ex. 1 | Ex. 2 | Comp. 3 |
|---|---|---|---|---|---|---|
| Component a) | parts by mass | 100 | 100 | 100 | 100 | 100 |
| Component b) | parts by mass | 21.5 | 21.5 | 23 | 25 | 21.5 |
| Component c) | parts by mass | 5.7 | | 5.7 | | 5.7 |
| Component c′) | parts by mass | | 10.8 | | 10.5 | |
| Component d) | parts by mass | | | 0.3 | 0.3 | |
| Component d′) | parts by mass | | | | | 0.3 |
| Flame retardant | Class | V-0 | V-0 | V-0 | V-0 | V-0 |
| Laser transparency | Reduction in transparency | +++ | +++ | +++ | +++ | +++ |
| Streaks after | Visual inspection | n.d. | n.d. | +++ | +++ | ++ |
| injection moulding | | | | | | |
| Browning after | Visual inspection by | RAL | RAL | RAL | RAL | RAL |
| injection moulding | comparison of RAL | 8001 | 8001 | 2001 | 2001 | 8023 |
| | shades ΔE < 10 | | | | | |

The test results listed in Tab. 2 show that, as well as the highest fire protection classification V-0, inventive examples 1 and 2 had excellent laser transparency (+++), and that the test specimens comprising flame retardant, flame retardant synergist and colourant were both free of streaks “+++” after injection moulding, i.e. not browned. The fact that the mixture of isomers to be used in accordance with the invention as colourant did not brown on injection moulding was shown by the injection-moulded product with RAL 2001. In the case of comparative examples Comp. 1 and Comp. 2, the fire protection classification V-O was achieved on the basis of the flame retardant/synergist combination, but the entry is n.d. for “not determined” because no colourant was used that could either have caused streaks on injection moulding or could have browned owing to the temperature in the course of compounding or on injection moulding. Both the inventive examples and the comparative examples consistently had an RAL colour value of 2001 with a ΔE of <10.

### Determination Methods

In the context of the present invention, the isomer distribution of the isomer mixture of 9,9′-oxybis-12H-phthaloperin-12-one, 9,10-oxybis-12H-phthaloperin-12-one and 10,10′-oxybis-12H-phthaloperin-12-one was determined by HPLC (high pressure liquid chromatography) and can be cited as a measure of colour brilliance of the polymer compositions described in Tab. 2 or of plastic products made therefrom by injection moulding in the form of 60·40·2 mm³ plaques, the C* value according to DIN EN ISO 11664-4 with a d/8° spectrophotometer in a colouristic measurement (D65 standard light, CIE 1976 L*a*b* Colour Space). HPLC is a liquid chromatography method by which it is possible not only to separate substances but also to identify and quantify (determine the exact concentration of) said substances via standards. The presence of colour streaks is attributable to the median particle size d50 to be determined according to ISO 13320 of the colourant to be used in accordance with the invention in the polymer compositions.

According to the invention, high laser transmittance means laser transmittance of at least 30%, preferably at least 40%, more preferably at least 50%, measured on sample plaques of a thickness of 0.75 mm with the LPKF TMG3 transmission measurement device from LPKF Laser 8 Electronics AG, Garbsen, Germany, at a laser wavelength of 980 nm. The measurements in the context of the present invention were based on DVS Guideline 2243 (January 2014) “Laserstrahlschweißen thermoplastischer Kunststoffe” using round plaques with diameter 80 mm and thickness 0.75 mm in the near infrared (NIR). The LPKF TMG3 transmission measurement device from LPKF Laser & Electronics AG was calibrated before the measurements with a measurement standard produced in accordance with DIN EN ISO/IEC 17025. The measurements were made in the context of the present invention at a laser wavelength of 980 nm.

A reduction in transmittance of <3% at 980 nm compared to a plastic sample without component d), the colourant in the form of the isomer mixture of 9,9′-oxybis-12H-phthaloperin-12-one, 9,10-oxybis-12H-phthaloperin-12-one and 10,10′-oxybis-12H-phthaloperin-12-one, is rated +++ in the context of the present invention. A reduction in transmittance at 980 nm in the range from 3% to 5% compared to a plastic sample without component d), the colourant in the form of the isomer mixture of 9,9′-oxybis-12H-phthaloperin-12-one, 9,10-oxybis-12H-phthaloperin-12-one and 10,10′-oxybis-12H-phthaloperin-12-one, is rated ++ in the context of the present invention. A reduction in transmittance at 980 nm in the range from 5% to 10% compared to a plastic sample without component d), the colourant in the form of the isomer mixture of 9,9′-oxybis-12H-phthaloperin-12-one, 9,10-oxybis-12H-phthaloperin-12-one and 10,10′-oxybis-12H-phthaloperin-12-one, is rated only + in the context of the present invention.

The detection of streaks after injection moulding was rated by visual inspection, with “+++” meaning free of streaks, “++” reduced streaks, and “−” containing streaks.

The detection of browning by injection moulding was effected by determining the RAL colour of the injection-moulded product by comparing it with a RAL colour chart. The most well-known RAL colours are defined in the RAL Classic System, which comprises 213 colours. These are identified by a four-digit number, beginning with “RAL”, and an optional colour name. An RAL colour chart is a physical colour fan that shows the different RAL colours. The shade of the injection-moulded product was determined by visual matching with the chart.

What is claimed is:

1. A plastic product made from a polymer composition comprising
a) at least one polyester;
b) at least one flame retardant composed of at least one phosphinic salt of formula (I) and/or at least one diphosphinic salt of formula (II) and/or polymers thereof 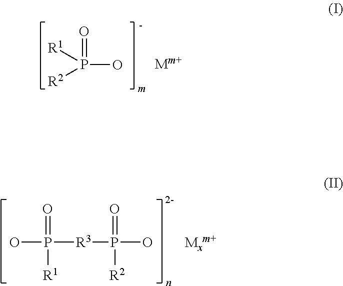
in which
R¹, R² are the same or different and are a linear or branched C₁-C₆-alkyl and/or C₆-C₁₄-aryl,
R³ is a linear or branched C₁-C₁₀-alkylene, C₆-C₁₀-arylene or C₁-C₆-alkyl-C₆-C₁₀-arylene or C₆-C₁₀-aryl-C₁-C₆-alkylene,
M is aluminium or zinc,
m is an integer from 1 to 4,
n is an integer from 1 to 3, and
x is 1 or 2,
where n, x and m in formula (II) may at the same time assume only such integer values so that the diphosphinic salt of formula (II) as a whole is uncharged;
c) at least one flame retardant synergist selected from melamine polyphosphate and aluminium phosphonate; and
d) at least one colourant in the form of an isomer mixture of 9,9′-oxybis-12H-phthaloperin-12-one, 9,10-oxybis-12H-phthaloperin-12-one and 10,10′-oxybis-12H-phthaloperin-12-one.

2. The plastic product according to claim 1, wherein the b) at least one flame retardant contains at least one phosphinic salt of formula (I) 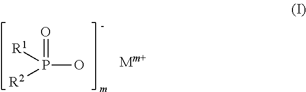
in which
R¹, R² are the same or different and are a linear or branched C₁-C₆-alkyl, M is aluminium or zinc, and m is an integer from 1 to 4.

3. The plastic product according to claim 1, wherein the plastic product has a colour distance ΔE<20, as determined according to DIN 5033 (1979), of the L*a*b* coordinates from a colour number beginning with “2” in the RAL colour chart according to EN ISO 11664-4.

4. The plastic product according to claim 1, wherein for every 100 parts by mass of the a) at least one polyester:
2 to 100 parts by mass of the b) at least one flame retardant,
0.2 to 50 parts by mass of the c) at least one flame retardant synergist, and
0.01 to 5 parts by mass of the d) at least one colourant are used.

5. The plastic product according to claim 1, wherein the b) at least one phosphinic salt of formula (II) is a dialkylphosphinic salt selected from the group consisting of aluminium methylethylphosphinate, aluminium trisdiethylphosphinate, aluminium isopropylisobutylphosphinate, aluminium isopropyl-tert-butylphosphinate, aluminium diisobutylphosphinate, aluminium trismethylethylphosphinate, zinc bisdiethylphosphinate, zinc bismethylethylphosphinate, and mixtures thereof.

6. The plastic product according to claim 1, wherein the b) at least one flame retardant is aluminium trisdiethylphosphinate.

7. The plastic product according to claim 3, wherein the plastic product has a shade in the RAL colour system that corresponds to colour number RAL2001, RAL2003, RAL2004, RAL2007, RAL2008, RAL2009, RAL2010 or RAL2011.

8. The plastic product according to claim 1, wherein the polymer composition further comprises e) at least one filler and/or reinforcer.

9. A plastic product according to claim 8, wherein the e) at least one filler and/or reinforcer is applied in an amount of 1 to 150 parts by mass based on 100 parts by mass of the at least one polyester.

10. The plastic product according to claim 9, wherein the e) at least one filler and/or reinforcer is selected from the group consisting of carbon fibres, solid or hollow glass beads, glass fibres, ground glass, amorphous quartz glass, aluminium borosilicate glass having an alkali content of 1% (E glass), amorphous silica, quartz flour, calcium silicate, calcium metasilicate, magnesium carbonate, kaolin, calcined kaolin, chalk, kyanite, powdered or ground quartz, mica, phlogopite, barium sulfate, feldspar, wollastonite, montmorillonite, pseudoboehmite of formula AlO(OH), magnesium carbonate, and talc.

11. The plastic product according to claim 10, wherein the e) at least one filler and/or reinforcer is glass fibres with an average starting length ranging from 1 to 50 mm, as determined by laser diffraction particle size analysis according to ISO 13320.

12. The plastic product according to claim 3, wherein such plastic product is a laser-transparent, orange, flame-retardant product or joining partner.

13. The plastic product according to claim 12, wherein the plastic product is a component for an electric drivetrain of a motor vehicle.

14. A process for producing plastic products comprising
mixing into a polymer composition
a) at least one polyester,
b) at least one flame retardant composed of at least one phosphinic salt of formula (I) and/or at least one diphosphinic salt of formula (II) and/or polymers thereof 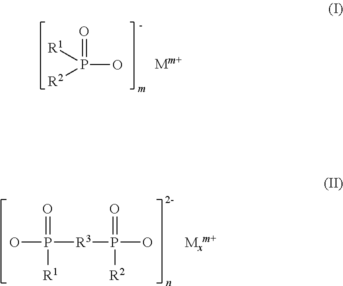
in which
R¹, R² are the same or different and are a linear or branched C₁-C₆-alkyl and/or C₆-C₁₄-aryl,
R³ is a linear or branched C₁-C₁₀-alkylene, C₆-C₁₀-arylene or C₁-C₆-alkyl-C₆-C₁₀-arylene or C₆-C₁₀-aryl-C₁-C₆-alkylene,
M is aluminium or zinc,
m is an integer from 1 to 4,
n is an integer from 1 to 3, and
x is 1 or 2,
where n, x and m in formula (II) may at the same time assume only such integer values so that the diphosphinic salt of formula (II) as a whole is uncharged,
c) at least one flame retardant synergist selected from melamine polyphosphate and aluminium phosphonate, and
d) at least one colourant in the form of an isomer mixture of 9,9′-oxybis-12H-phthaloperin-12-one, 9,10-oxybis-12H-phthaloperin-12-one and 10,10′-oxybis-12H-phthaloperin-12-one,
extruding the polymer composition into strands;
cooling the strands until pelletizable;
drying and pelletizing; and
processing the pellets further by injection moulding, by extrusion methods, or by blow moulding.

15. The process according to claim 14, wherein the plastic product has a colour distance ΔE<20, to be determined according to DIN 5033 (1979), of the L*a*b* coordinates from a colour number beginning with “2” in the RAL colour chart according to EN ISO 11664-4.

16. The process according to claim 14, wherein for every a) 100 parts by mass of the at least one polyester:
b) 2 to 100 parts by mass of the at least one flame retardant,
c) 0.2 to 50 parts by mass of the at least one flame retardant synergist, and
d) 0.01 to 5 parts by mass of the at least one colourant are used.

17. The process according to claim 16, wherein the a) at least one polyester is a C₂-C₁₀-polybutylene alkylene terephthalate or polycarbonate.

18. The process according to claim 17, wherein the C₂-C₁₀-polybutylene alkylene terephthalate is polybutylene terephthalate.

19. A method of preparing an orange, flame-retardant plastic product comprising adding a colourant containing an isomer mixture in the form of 9,9′-oxybis-12H-phthaloperin-12-one, 9,10-oxybis-12H-phthaloperin-12-one and 10,10′-oxybis-12H-phthaloperin-12-one to a flame-retardant polymer composition which comprises
a) at least one polyester,
b) at least one flame retardant composed of at least one phosphinic salt of formula (I) and/or at least one diphosphinic salt of formula (II) and/or polymers thereof 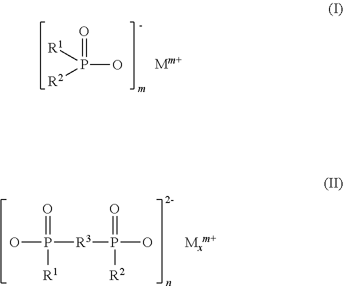
in which
R¹, R² are the same or different and are a linear or branched C₁-C₆-alkyl and/or C₆-C₁₄-aryl,
R³ is a linear or branched C₁-C₁₀-alkylene, C₆-C₁₀-arylene or C₁-C₆-alkyl-C₆-C₁₀-arylene or C₆-C₁₀-aryl-C₁-C₆-alkylene,
M is aluminium or zinc,
m is an integer from 1 to 4,
n is an integer from 1 to 3, and
x is 1 or 2,
where n, x and m in formula (II) may at the same time assume only such integer values so that the diphosphinic salt of formula (II) as a whole is uncharged, and
c) at least one flame retardant synergist selected from melamine polyphosphate and aluminium phosphonate.

20. The method according to claim 19, wherein the plastic product has a colour distance ΔE<20, as determined according to DIN 5033 (1979), of the L*a*b* coordinates from a colour number beginning with “2” in the RAL colour chart according to EN ISO 11664-4.

21. The method according to claim 19, wherein for every 100 parts by mass of the a) at least one polyester,
2 to 100 parts by mass of the b) at least one flame retardant,
0.2 to 50 parts by mass of the c) at least one flame retardant synergist, and
0.01 to 5 parts by mass of the d) at least one colourant are used.

22. The method according to claim 21, wherein the a) at least one polyester is a C₂-C₁₀-polybutylene alkylene terephthalate or polycarbonate.

23. A method according to claim 22, wherein the C₂-C₁₀-polybutylene alkylene terephthalate is polybutylene terephthalate.
